(19) United States
(12) Patent Application Publication
(10) Pub. No.: US 2016/0293926 A1
(43) Pub. Date: Oct. 6, 2016

(54) PRISMATIC SECONDARY BATTERY AND ASSEMBLED BATTERY USING THE SAME

(71) Applicant: Sanyo Electric Co., Ltd., Osaka (JP)

(72) Inventor: Masakazu Yamada, Hyogo (JP)

(73) Assignee: Sanyo Electric Co., Ltd., Osaka (JP)

(21) Appl. No.: 15/065,241

(22) Filed: Mar. 9, 2016

(30) Foreign Application Priority Data
Mar. 30, 2015 (JP) 2015-068196

(51) Int. Cl. H01M 2/26; H01M 2/06; H01M 2/12; H01M 2/34; H01M 2/02

(52) U.S. Cl. CPC H01M 2/26; H01M 2/345; H01M 2/024; H01M 2/12; H01M 2/06; H01M 2200/20; H01M 2220/20

(57) ABSTRACT

A prismatic outer body includes an opening, a bottom, a pair of large-area side walls, and a pair of small-area side walls. The opening is sealed by a sealing plate, a flat-shaped electrode body is housed in the prismatic outer body, a positive electrode tab portion and a negative electrode tab portion are disposed on one end of the electrode body closer to the sealing plate than the other end and are electrically connected to a positive electrode terminal and a negative electrode terminal attached to the sealing plate, and a gas release valve is formed in the bottom of the prismatic outer body.

### CROSS REFERENCE TO RELATED APPLICATIONS:

The present invention application claims priority to Japanese Patent Application No. 2015-068196 filed in the Japan Patent Office on Mar. 30, 2015, the entire contents of which are incorporated herein by reference.

### BACKGROUND OF THE INVENTION

1. Field of the Invention

The present disclosure relates to a prismatic secondary battery and an assembled battery using the prismatic secondary battery.

2. Description of Related Art

In drive power supplies of electric vehicles (EV) and hybrid electric vehicles (HEV, PHEV), a secondary battery such as an alkaline secondary battery or a nonaqueous electrolyte secondary battery is used. For these applications, high capacity or high output characteristics is demanded, and thus an assembled battery is used in which a large number of prismatic secondary batteries are connected in series or in parallel.

In those prismatic secondary batteries, a battery case is formed by a bottomed tubular prismatic outer body having an opening, and a sealing plate that seals the opening. An electrode body including a positive electrode plate, a negative electrode plate, and a separator is housed in the battery case along with an electrolyte solution. A positive electrode terminal and a negative electrode terminal are fixed to the sealing plate. The positive electrode terminal is electrically connected to the positive electrode plate via a positive electrode current collector, and the negative electrode terminal is electrically connected to the negative electrode plate via a negative electrode current collector.

The positive electrode plate includes a positive electrode core made of metal, and a positive electrode active material layer formed on the surface of the positive electrode core. In part of the positive electrode core, a positive electrode core exposed portion is formed in which a positive electrode active material layer is not formed. The positive electrode current collector is then connected to the positive electrode core exposed portion. Also, the negative electrode plate includes a negative electrode core made of metal, and a negative electrode active material layer formed on the surface of the negative electrode core. In part of the negative electrode core, a negative electrode core exposed portion is formed in which a negative electrode active material layer is not formed. The negative electrode current collector is then connected to the negative electrode core exposed portion.

For instance, Japanese Published Unexamined Patent Application No. 2009-032640 (Patent Document 1) proposes a prismatic secondary battery using a winding electrode body which has a positive electrode core exposed portion wound at one end and a negative electrode core exposed portion wound at the other end. Also, Japanese Published Unexamined Patent Application No. 2008-226625 (Patent Document 2) proposes a prismatic secondary battery using a winding electrode body which is provided with a positive electrode core exposed portion and a negative electrode core exposed portion at one end.

### BRIEF SUMMARY OF THE INVENTION

Regarding in-vehicle secondary batteries, particularly secondary batteries used for EV or PHEV, development of a large-capacity secondary battery having a higher volume energy density is called for. In the case of the prismatic secondary battery disclosed in Patent Document 1, the battery case needs the space on the right and left for disposing wound positive electrode core exposed portion and wound negative electrode core exposed portion and needs an upper space between a sealing plate and a winding electrode body. This is a factor that makes it difficult to increase the volume energy density of the secondary battery.

On the other hand, when a winding electrode body provided with a positive electrode core exposed portion and a negative electrode core exposed portion at one end is used as in the prismatic secondary battery disclosed in Patent Document 2, a prismatic secondary battery having a high volume energy density is likely to be obtained.

An object of the present disclosure is to provide a highly reliable high-capacity prismatic secondary battery having a high volume energy density and an assembled battery using the prismatic secondary battery.

A prismatic secondary battery according to an aspect of the present disclosure includes: an electrode body including a positive electrode plate and a negative electrode plate; a positive electrode tab portion electrically connected to the positive electrode plate; a negative electrode tab portion electrically connected to the negative electrode plate; a prismatic outer body that has an opening and that houses the electrode body; a sealing plate that seals the opening; a positive electrode terminal that is electrically connected to the positive electrode plate and attached to the sealing plate; and a negative electrode terminal that is electrically connected to the negative electrode plate and attached to the sealing plate. The prismatic outer body includes a bottom, a pair of large-area side walls, and a pair of small-area side walls, an area of each of the small-area side walls is smaller than an area of each of the large-area side walls, an area of the bottom s smaller than the area of each of the small-area side walls, the electrode body has the positive electrode tab portion and the negative electrode tab portion at one end closer to the sealing plate than the other, and a gas release valve is formed through which a gas in the battery is released to an outside of the battery when an internal pressure of the battery reaches a predetermined value or higher.

With this configuration, the electrode body has, at its end near the sealing plate, the positive electrode tab portion and the negative electrode tab portion. In the battery case constituted by the prismatic outer body and the sealing plate, the bottom of the prismatic outer body and the surface of the sealing plate have a smaller area than other lateral faces. Therefore, space not involved in power generation in the battery case may be reduced a minimum and thus a high-capacity prismatic secondary battery having an extremely high volume energy density is achieved.

In the case of a secondary battery having an extremely large battery capacity, the amount and/or speed of generated gas at the time of abnormality are extremely high. Therefore, in the case where the internal pressure of the battery increases, it is preferable to release the gas in the battery to the outside of the battery.

Since the bottom of the prismatic outer body is provided with a gas release valve in the above-described prismatic secondary battery, it is possible to provide a sufficiently large gas release valve in the battery case without being limited by the disposition space for the positive electrode terminal and the negative electrode terminal. Consequently, a highly reliable prismatic secondary battery is obtained in which even when abnormality occurs in the secondary battery and the internal pressure thereof increases, the gas in the battery case can be immediately released to the outside of the battery.

In addition, between the bottom included in the prismatic outer body, the pair of large-area side walls, and the pair of small-area side walls, the bottom, which is most unlikely to be deformed as the internal pressure of the battery increases, is provided with a gas release valve, thereby making it possible to reduce a variation in the operating pressure of the gas release valve. Therefore, a more reliable prismatic secondary battery is achieved. It is preferable that the thickness of the bottom he greater than the thickness of each large-area side wall and greater than the thickness of each small-area side wall.

The present disclosure is particularly effective when the battery capacity is 25 Ah or higher. The present disclosure is further effective when the battery capacity is 30 Ah or higher. It is to be noted that the value of battery capacity may be a designed capacity, that is, the value of the nominal capacity specified by a manufacturer of batteries.

It is preferable that the length of each of the large-area side walls in a long side direction be 10 to 20 cm, and the length of each of the large-area side walls in a short side direction is 5 to 10 cm. With this configuration, even when the size of the battery case is increased, it is possible to reduce the area of the bottom, where the gas release valve is formed, of the prismatic outer body having a high volume energy density. This makes it possible to reduce deformation of the entire bottom due to an increase of the internal pressure of the battery. Thus, a more reliable prismatic secondary battery is obtained.

It is to be noted that the ratio of the length of each large-area side wall in a long side direction to the length of each large-area side wall in a short side direction is preferably 1.2 or greater, and more preferably 1.5 or greater.

The length of the short-area side wall in a short side direction is preferably 1 to 5 cm. The length of the short-area side wall in a short side direction is more preferably 2 to 4 cm.

A configuration may adopted in which the sealing plate has a first through hole and a second through hole, the positive electrode terminal is inserted in the first through hole, the negative electrode terminal is inserted in the second through hole, a positive electrode external connection member is connected to the positive electrode terminal on an outer side of the sealing plate with respect to the battery, and a positive electrode fastener is connected to the positive electrode external connection member, a negative electrode external connection member is connected to the negative electrode terminal on the outer side of the sealing plate with respect to the battery, and a negative electrode fastener is connected to the negative electrode external connection member, and the positive electrode fastener is disposed at a position displaced from the first through hole and the negative electrode fastener is disposed at a position displaced from the second through hole longitudinal direction of the sealing plate.

With this configuration, when the fasteners of adjacent prismatic secondary batteries are connected by a bus bar or the like to produce an assembled battery, an adverse effect on the terminals caused by a torque applied to the fasteners may be reduced.

It is preferable that the positive electrode fastener be a positive electrode bolt member, and the negative electrode fastener be a negative electrode bolt member. It is to be noted that a nut may serve as the fastener.

A configuration may adopted in which the prismatic secondary battery further includes a short circuit mechanism that operates as an internal pressure of the battery increases, the short circuit mechanism including a deformation plate provided in the sealing plate, and a deformation plate receiver that is disposed on an outer side of the deformation plate to face the deformation plate. The deformation plate is electrically connected to one of the positive electrode plate and the negative electrode plate, the deformation plate receiver is electrically connected to the other of the positive electrode plate and the negative electrode plate, and the deformation plate is deformed as the internal pressure of the battery increases, and is electrically connected to the deformation plate receiver.

It is preferable that a spacer be disposed between the electrode body and the bottom, and a through hole be formed in the spacer.

An assembled battery according to an aspect of the present disclosure includes a plurality of the prismatic secondary batteries described above, the assembled battery including a pair of end plates; and a bind bar that connects the pair of end plates. The prismatic secondary batteries are stacked between the pair of end plates in an orientation in which the respective large-area side walls are parallel, the positive electrode terminal and the negative electrode terminal of each of the prismatic secondary batteries are disposed on one lateral face, and the bottom of the prismatic outer body of each of the prismatic secondary batteries is disposed on the other lateral face.

According to the present disclosure, it is possible to provide a high-capacity prismatic secondary battery having a high volume energy density and an assembled battery using the prismatic secondary battery.

### BRIEF DESCRIPTION OF THE SEVERAL VIEWS OF THE DRAWINGS

FIG. 1 illustrates a perspective view of a prismatic secondary battery according to an embodiment.

FIG. 2 is a sectional view taken along line II-II of FIG. 1.

FIG. 3 is an enlarged view of a positive electrode terminal and its periphery in FIG. 2.

FIG. 4 is a view illustrating the sealing plate-side face of the prismatic secondary battery.

FIG. 5 is a view illustrating the bottom-side face of the prismatic secondary battery.

FIG. 6 is a perspective view of a bottom-side spacer used for the prismatic secondary battery.

FIGS. 7A to 7C are each a view illustrating the bottom of a prismatic secondary battery as a modification.

FIG. 8 is a sectional view taken along line VIII-VIII in FIG. 7C.

FIGS. 9A and 9B are each a perspective view of a bottom-side spacer according to a modification.

FIG. 10 is a sectional view of a prismatic secondary battery as a modification, the view corresponding to FIG. 2.

FIG. 11 is a view illustrating the sealing plate-side face of the prismatic secondary battery.

FIG. 12 is a perspective view of an assembled battery according to the embodiment.

FIG. 13 is a perspective view of the assembled battery according to the embodiment.

FIG. 14 is a sectional view of a current cutoff mechanism.

### DETAILED DESCRIPTION OF THE INVENTION

A prismatic secondary battery according to an embodiment will be described below. It is to be noted that the present disclosure is not limited to the following embodiment.

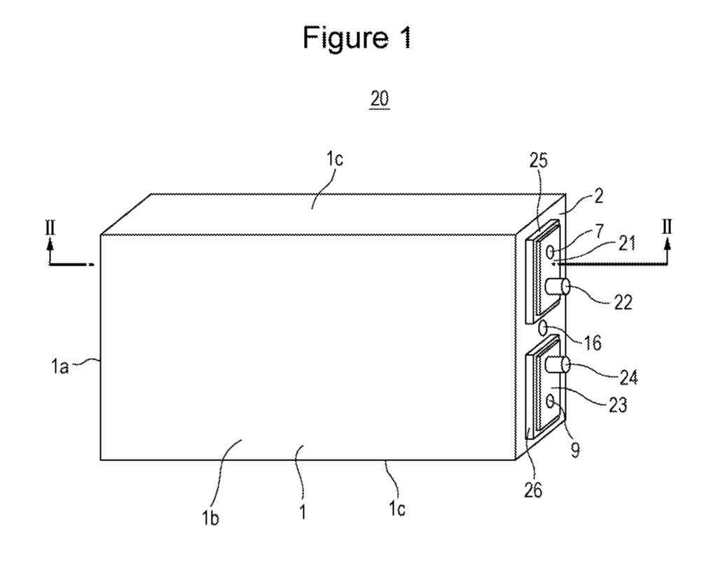

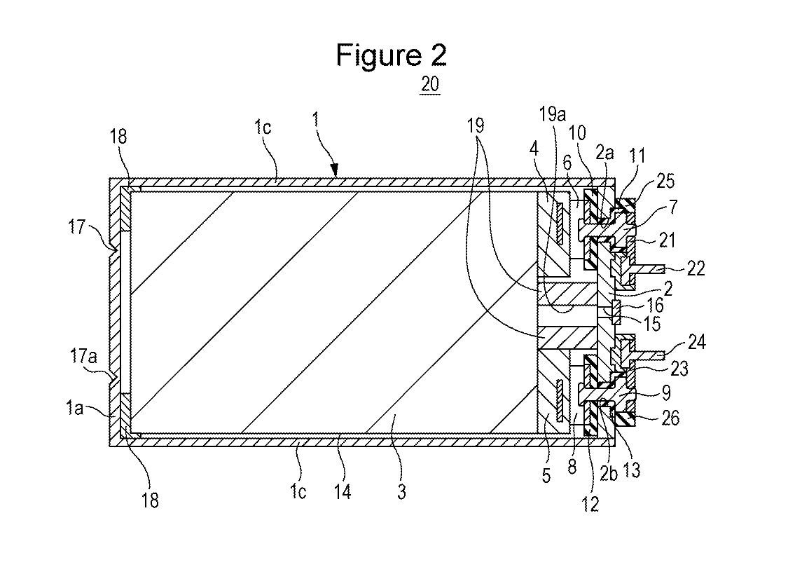

As illustrated in FIG. 1 and FIG. 2, a prismatic secondary battery 20 includes a prismatic outer body 1 having an opening, and a sealing plate 2 that seals the opening. The prismatic outer body 1 and the sealing plate 2 constitute a battery case. The prismatic outer body 1 and the sealing plate 2 are each preferably made of metal, and for instance, may be made of aluminum or aluminum alloy. A flat-shaped electrode body 3, in which a positive electrode plate and a negative electrode plate are stacked via a separator (those components are not illustrated), are housed in the prismatic outer body 1 together with an electrolyte. The electrode body 3 is housed in the prismatic outer body 1 with wrapped by an insulating sheet 14 which is formed in a bag shape or a box shape. A positive electrode tab portion 4 electrically connected to the positive electrode plate and a negative electrode tab portion 5 electrically connected to the negative electrode plate are disposed at one end of the electrode body 3.

The positive electrode plate is such that a positive electrode active material layer including a positive electrode active material is formed on a positive electrode metal core. A positive electrode core exposed portion, where the positive electrode core is exposed, is formed in the positive electrode plate. The positive electrode core exposed portion may serve as the positive electrode tab portion 4. Alternatively, a metal tub member is connected to the positive electrode core exposed portion which may serve as the positive electrode tab portion 4. It is to be noted that aluminum foil or aluminum alloy foil is preferably used for the positive electrode core.

The negative electrode plate is such that a negative electrode active material layer including a negative electrode active material is formed on a negative electrode metal core. A negative electrode core exposed portion,where the negative electrode core is exposed, is formed in the negative electrode plate. The negative electrode core exposed portion may serve as the negative electrode tab portion 5. Alternatively, a metal tub member is connected to the negative electrode core exposed portion which may serve as the negative electrode tab portion 5. It is to be noted that copper foil or copper alloy foil is preferably used for the negative electrode core.

A positive electrode current collector 6 is connected to the positive electrode tab portion 4. A positive electrode terminal 7 is connected to the positive electrode current collector 6. The positive electrode terminal 7 is inserted in a terminal mounting hole (a first through hole) 2a provided in the sealing plate 2. An insulating member 10 and a gasket 11 are disposed between the positive electrode terminal 7 and the sealing plate 2 to electrically insulate the positive electrode terminal 7 and the sealing plate 2 from each other. A positive electrode external connection member 21 is connected to the positive electrode terminal 7 outwardly of the sealing plate 2, and a positive electrode fastener 22 is connected to the positive electrode external connection member 21. It is to be noted that the insulating member 10 and the gasket 11 are preferably an insulating resin member.

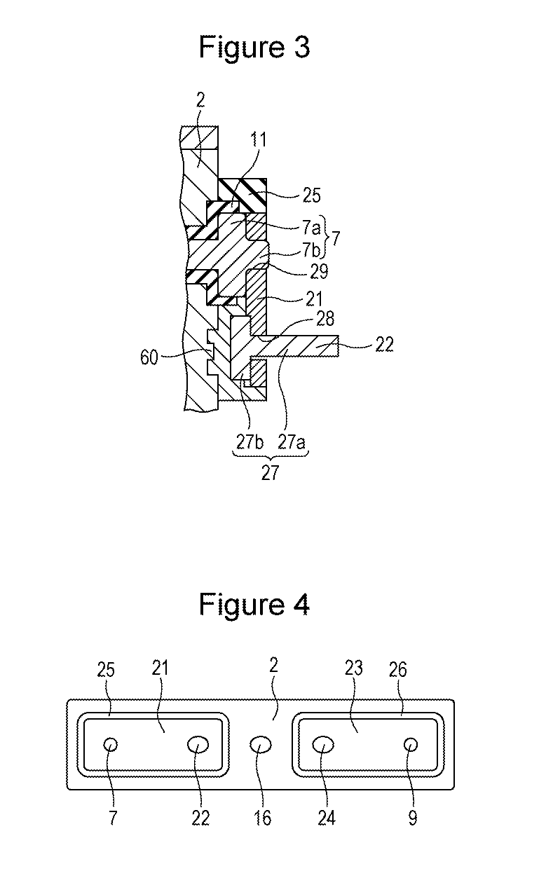

As illustrated in FIG. 3 and FIG. 4, the positive electrode external connection member 21 is preferably a plate-shaped metal member. For instance, the positive electrode external connection member 21 may be an aluminum plate. Also, the positive electrode fastener 22 is preferably a bolt member. As illustrated in FIG. 3, the positive electrode listener 22 is a bolt member 27, and has a bolt portion 27a and a head portion 27b provided at the end of the bolt portion 27a. Also, the positive electrode external connection member 21 has a bolt insertion hole 28. The bolt member 27 is inserted in the bolt insertion hole 28 of the positive electrode external connection member 21 from the side of the sealing plate 2. An external insulating member 25 made of resin is disposed between the positive electrode external connection member 21, the positive electrode fastener 22, and the sealing plate 2. It is preferable that the sealing plate 2 and the external insulating member 25 be connected by fitting or the like to each other at a position corresponding to the positive electrode fastener 22. For instance, the sealing plate 2 is provided with a depressed portion or a projecting portion, and the external insulating member 25 is provided in the depressed portion or the projecting portion. It is preferable that the depressed portion or the projecting portion of the sealing plate 2 and the projecting portion or the depressed portion of the external insulating member 25 be fitted to each other to provide a fitting portion 60.

It is to be noted that the gasket 11 and the external insulating member 25 may be integrated as one component.

A negative electrode current collector 8 is connected to the negative electrode tab portion 5. A negative electrode terminal 9 is connected to the negative electrode current collector 8. The negative electrode terminal 9 is inserted in a terminal mounting hole (a second through hole) 2b provided in the sealing plate 2. An insulating member 12 and a gasket 13 are disposed between the negative electrode terminal 9 and the sealing plate 2 to electrically insulate the negative electrode terminal 9 and the sealing plate 2 from each other. A negative electrode external connection member 23 is connected to the negative electrode terminal 9 outwardly of the sealing plate 2, and a negative electrode fastener 24 is connected to the negative electrode external connection member 23. An external insulating member 26 made of resin is disposed between the negative electrode external connection member 23, the negative electrode fastener 24, and the sealing plate 2. It is to be noted that the insulating member 12 and the gasket 13 are preferably an insulating resin member.

The configurations of the negative electrode terminal 9, the negative electrode external connection member 23, the negative electrode fastener 24, and the external insulating member 26 may be the same as those on the positive electrode side.

When an assembled battery is produced using a plurality of prismatic secondary batteries 20, a bus bar is connected to the positive electrode fastener 22 and the negative electrode fastener 24 of adjacent prismatic secondary batteries 20.

An electrolyte solution injection hole 15 is formed at a central portion of the sealing plate 2 in the longitudinal direction of the sealing plate 2. The electrolyte solution injection hole 15 is sealed by a sealing plug 16.

The prismatic outer body 1 has a bottomed tubular prismatic shape. The prismatic outer body 1 has a bottom 1a, a pair of large-area side walls 1b, and a pair of small-area side walls 1c. The bottom 1a is located to be opposed to the opening, and is disposed in parallel to the sealing plate 2. The pair of large-area side walls 1b are opposed to each other. Also, the pair of small-area side walls 1c are opposed to each other. The pair of large-area side walls 1b and the pair of small-area side walls 1c are each disposed perpendicular to the bottom la_{—} The area of each large-area side wall 1b is greater than the area of each small-area side wall 1c. It is to be noted that the area of the bottom 1a and the area of the sealing plate 2 are smaller than the area of each small-area side wall 1c. It is to be noted that each area indicates the area of a portion surrounded by the outer peripheral edge in plan view, and the depressions and projections on the surface are not taken into consideration.

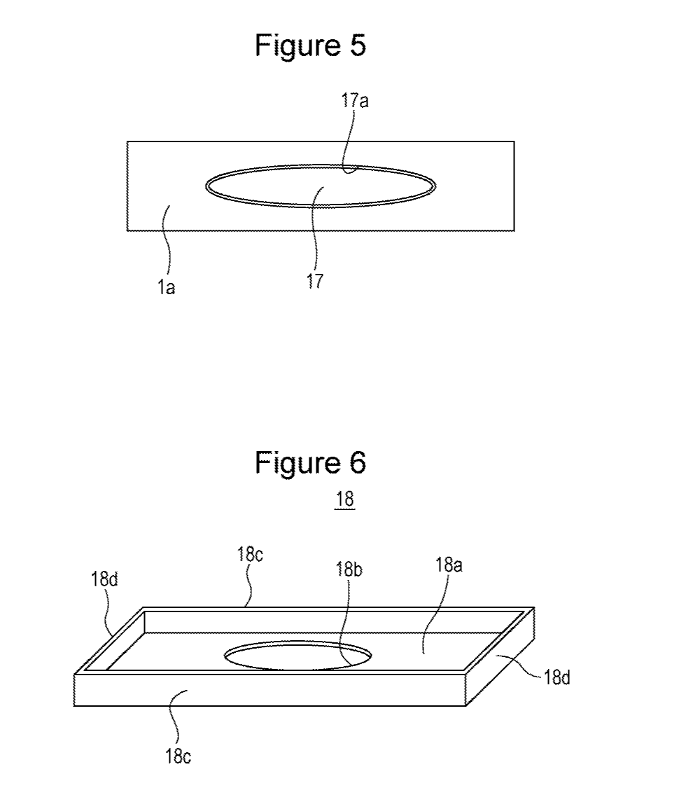

As illustrated in FIG. 2 and FIG. 5, a gas release valve 17 is provided in the bottom 1a of the prismatic outer body 1. The gas release valve 17 breaks when the pressure inside the battery becomes higher than a predetermined value, and the gas inside the battery is released to the outside of the battery. In the prismatic secondary battery 20, the bottom 1a is provided with a ring-shaped groove 17a, thereby forming a gas release valve. With this configuration, when the internal pressure of the battery becomes higher than a predetermined value, the groove 17a having a less thickness than other portions breaks and gas is released to the outside of the battery.

As illustrated in FIG. 2, a bottom-side spacer 18 is preferably disposed between the bottom 1a of the prismatic outer body 1 and the electrode body 3. The disposition of the bottom-side spacer 18 between the bottom 1a of the prismatic outer body 1 and the electrode body 3 makes it possible to protect the gas release valve 17 against damage by the electrode body 3 even when the electrode body 3 moves in the prismatic outer body 1 due to vibration or impact.

FIG. 6 is a perspective view of the bottom-side spacer 18. The bottom-side spacer 18 has a plate-shaped main body 18a. A spacer through hole 18b is formed in the main body 18a. This reliably avoids delay of the operation of the gas release valve 17 due to the bottom-side spacer 18. A long side wall 18c may be provided along the long side of the main body 18a. Also, a short side wall 18d may be provided along the short side of the main body 18a. Movement of the electrode body 3 in the prismatic outer body 1 may he restricted by disposing the long side wall 18c or the short side wall 18d between the large-area side walls 1b or the small-area side walls 1c of the prismatic outer body 1 and the electrode body 3.

A sealing plate-side spacer 19 is preferably disposed between the electrode body 3 and the sealing plate 2. This makes it possible to restrict the movement of the electrode body 3 in the prismatic outer body 1. A through hole 19a is preferably formed at a position in the sealing plate-side spacer 19, the position corresponding to the electrolyte solution injection hole 15.

In the battery case formed by the prismatic outer body 1 and the sealing plate 2 of the prismatic secondary battery 20, the bottom 1a of the prismatic outer body 1 and the sealing plate 2 are smaller in area than the other faces. In addition, the positive electrode tab portion 4 and the negative electrode tab portion 5 are provided at one end of the electrode body 3, and the positive electrode tab portion 4 and the negative electrode tab portion 5 are disposed on the side of the sealing plate 2. Thus, the space not involved in power generation in the battery case may be reduced to a minimum, and therefore, a high-capacity prismatic secondary battery having a high volume energy density is achieved. In addition, by providing the gas release valve 17 in the bottom 1a of the prismatic outer body 1, the gas release valve 17 having a sufficiently large area is achieved without considering the disposition space for the positive electrode terminal 7 and the negative electrode terminal 9, and thus a, highly reliable prismatic secondary battery is achieved.

Furthermore, in the prismatic outer body 1, the bottom 1a is more resistant to deformation than the pair of large-area side walls 1b and the pair of small-area side walls 1c even in the case where the internal pressure of the battery increases. Therefore, a variation in the operating pressure of the gas release valve 17 is reduced.

It is preferable that the thickness of the bottom is (the thickness of a base material portion where the gas release valve 17 is not formed) be greater than the thickness of each large-area side wall and greater than the thickness of each small-area side wall. With this configuration, deformation of the bottom 1a is reduced even when the internal pressure of the battery increases.

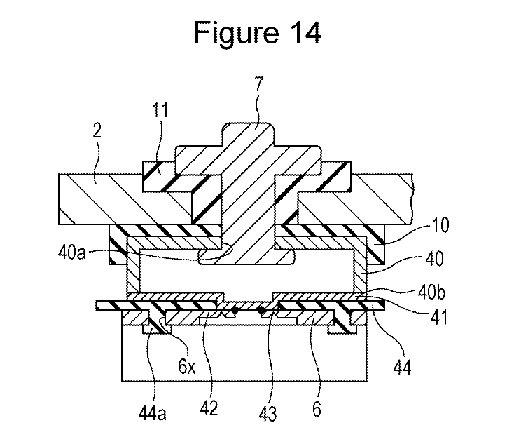

When the bottom 1a of the prismatic outer body 1 is seen in plan view, the area of the gas release valve 17 is preferably 15% or greater of the area of the bottom 1a. Thus, even when the battery capacity is extremely high, for instance, even when the battery capacity 30 Ah or higher, the gas in the battery may be released to the outside of the battery in a shorter time in the case where the internal pressure of the battery increases. The area of the gas release valve 17 is preferably 20% or greater of the area of the bottom 1a, and more preferably 30% or greater of the area of the bottom 1a. It is to be noted that the area of the gas release valve refers to the area of an opening which is formed in the bottom 1a when the gas release valve operates. For instance, in FIG. 14, the area of the portion rounded by the ring-shaped groove 17a defines the area of the gas release valve.

As illustrated in FIG. 2 and FIG. 3, the positive electrode fastener 22 is disposed at a position displaced from the positive electrode terminal 7 in the longitidinal direction of the sealing plate 2, and the negative electrode fastener 24 is disposed at a position displaced from negative electrode terminal 9 in the longitudinal direction of the sealing plate 2. With this configuration, when a bus bar is connected to a fastener by a bolt and a nut, application of torque to the positive electrode terminal 7 or the negative electrode terminal 9 may be restricted. Therefore, it is possible to avoid decrease in airtightness between the positive electrode terminal 7 and the sealing plate 2 and between the negative electrode terminal 9 and the sealing plate 2 and to avoid damage to the connecting portion between the positive electrode terminal 7 and the positive electrode current collector 6 and the connecting portion between the negative electrode terminal 9 and the negative electrode current collector 8.

The prismatic secondary battery 20 has a structure in which the positive electrode fastener 22 and the negative electrode fastener 24 are displaced to the central side from the positive electrode terminal 7 and the negative electrode terminal 9, respectively in the longitudinal direction of the sealing plate 2. However, the positive electrode fastener 22 and the negative electrode fastener 24 may be displaced to the outer side from the positive electrode terminal 7 and the negative electrode terminal 9, respectively in the longitudinal direction of the sealing plate 2. Specifically, the respective mounting holes on the positive electrode side and the negative electrode side are formed near the center in the sealing plate 2. The positive electrode fastener 22 is disposed outwardly of the positive electrode terminal 7 and the negative electrode fastener 24 is disposed outwardly of the negative electrode terminal 9 in the longitudinal direction of the sealing plate 2. In other words, the distance between the positive electrode fastener 22 and the negative electrode fastener 24 is made greater than the distance between the positive electrode terminal 7 and the negative electrode terminal 9. Consequently, even when the length of the sealing plate 2 in the longitudinal direction is short, the distance between the positive electrode fastener 22 and the negative electrode fastener 24 can be increased. Therefore, workability of connecting the positive electrode fastener 22 and the negative electrode fastener 24 by a bus bar is not reduced. In addition, short circuit between the positive and negative electrodes is reliably protected.

In the prismatic secondary battery 20, a conductive path between the positive electrode plate and the positive electrode terminal 7 or a conductive path between the negative electrode plate and the negative electrode terminal 9 is preferably provided with a pressure sensitive current cutoff mechanism that operates in the case where the internal pressure of the battery reaches a predetermined value or higher. Thus, the reliability of the secondary battery in an overcharge state improves.

FIG. 14 illustrates an example of a pressure sensitive current cutoff mechanism. FIG. 14 is a sectional view of the current cutoff mechanism and corresponds to FIG. 2 and FIG. 3. A cup-shaped conductive member 40 having a tubular portion is disposed on the lower surface of the insulating member 10. The conductive member 40 has a through hole 40a in its bottom close to the insulating member 10 the positive electrode terminal 7 is inserted in the through hole 40a, and the conductive member 40 is connected to the positive electrode terminal 7. The conductive member 40 has an opening 40b on the inner side of the battery. A deformation plate 41 is disposed so as to seal the opening 40b. The peripheral edge of the deformation plate 41 is weld-connected to the conductive member 40, and the opening is sealed by the deformation plate 41. The positive electrode current collector 6 is connected to the surface, on the inner side of the battery, of the deformation plate 41. The positive electrode current collector 6 has a through hole, the edge of which is weld-connected to the deformation plate 41. In the periphery of a portion which is weld-connected, a thin-walled portion 42 is formed. Also, a ring-shaped groove 43 is formed in the thin-walled portion 42. When the pressure inside the battery increases, a central portion of the deformation plate 41 is deformed so as to move upward toward the sealing plate 2. In conjunction with this, the connecting portion between the deformation plate 41 and the positive electrode current collector 6 is pulled toward the sealing plate 2 and the ring-shaped groove 43 breaks. Thus, the conductive path between the positive electrode plate and the positive electrode terminal 7 is cut off and charging current is blocked. This allows protection against further overcharge. It is to he noted that the operating pressure of the current cutoff mechanism is preferably lower than the operating pressure of the gas release valve 17.

It is to be noted that an insulating plate 41 made of resin is disposed between the deformation plate 41 and the positive electrode current collector 6. The insulating plate 44 is latched and fixed to the insulating plate 10 (not illustrated). The insulating plate 44 has a projection 14a, and the projection 14a is inserted in a through hole 6x for fixation formed in the positive electrode current collector 6, and the diameter of the end of the projection 44a is expanded. Thus, the insulating plate 44 and the positive electrode current collector 6 are connected and fixed.

### <Production of Positive Electrode Plate>

A method of manufacturing the prismatic secondary battery 20 will he described in the following. Positive electrode slurry including lithium cobalt oxide as a positive electrode active material polyvinylidene fluoride (PVdF) as a binder, a carbon material as a conductive material, and N-methylpyrrolidone (NMP) is produced. The positive electrode slurry is applied to both sides of a 15 μm-thick rectangular aluminum foil which is the positive electrode core. By drying the positive electrode slurry, the N-methylpyrrolidone in the positive electrode slurry is removed, and a positive electrode active material layer is formed on the positive electrode core. Subsequently, compression processing is performed so that the positive electrode active material layer has a predetermined thickness. The positive electrode plate thus obtained is cut so that the positive electrode core exposed portions with a predetermined width are formed with predetermined intervals at one widthwise end of the positive electrode plate. The positive electrode core exposed portions each serve as the positive electrode tab portion 4.

### <Production of Negative Electrode Plate>

A negative electrode slurry including graphite as a negative electrode active material, styrene-butadiene rubber (SBR) as a binder, carboxymethyl cellulose (CMC) as a thickening agent, and water is produced. The negative electrode slimy is applied to both sides of a 8 μm-thick rectangular copper foil which is the negative electrode core. By drying the negative electrode slurry, the water in the negative electrode slurry is removed, and a negative electrode active material layer is formed on the negative electrode core. Subsequently, compression processing is performed so that the negative electrode active material layer has a predetermined thickness. The negative electrode plate thus obtained is cut so that the negative electrode core exposed portions with a predetermined width are formed with predetermined intervals at one widthwise end of the negative electrode plate. The negative electrode core exposed portions each serve as the negative electrode tab portion 5.

### <Production of Winding Electrode Body>

The positive electrode plate and the negative electrode plate obtained by the above-described method are slid so that no overlap occurs between the positive electrode tab portions 4 and the negative electrode tab portions 5, and a porous separator made of polyethylene is interposed between the positive electrode plate and the negative electrode plate, which are stacked, wound, and pressed. Thus, a flat-shaped winding electrode body 3 is formed in which stacked positive electrode tab portions 4 and stacked negative electrode tab portions 5 are formed at one end of the winding electrode body 3 in the winding axis direction. In the electrode body 3, the length in the direction in which the winding axis extends (the length in the crosswise direction in FIG. 2) is greater than the width perpendicular to the winding axis extending direction and the thickness direction (the width in the vertical direction in FIG. 2).

### <Mounting of Terminal and Current Collector to Sealing Plate>

The gasket 11 is disposed outwardly of the terminal mounting hole of the sealing plate 2, and the insulating member 10 and the positive electrode current collector 6 are disposed inwardly of the terminal mounting hole of the sealing plate 2. From the outer side of the battery, the positive electrode terminal 7 is inserted in a through hole formed in each of the gasket 11, the sealing plate 2, the insulating member 10, and the positive electrode current collector 6, and the distal end of the positive electrode terminal 7 is swaged, and thus the positive electrode terminal 7 and the positive electrode current collector 6 are mounted on the sealing plate 2. The gasket 13 is disposed outwardly of the terminal mounting hole of the sealing plate 2, and the insulating member 12 and the negative electrode current collector 8 are disposed inwardly of the terminal mounting hole of the sealing plate 2. From the outer side of the battery, the negative electrode terminal 9 is inserted in a through hole formed in each of the gasket 13, the sealing plate 2, the insulating member 12, and the negative electrode current collector 8, and the distal end of the negative electrode terminal 9 is swaged, and thus the negative electrode terminal 9 and the negative electrode current collector 8 are mounted on the sealing plate 2. It is to be noted that the connecting portion between the positive electrode terminal 7 and the positive electrode current collector 6 and the connecting portion between the negative electrode terminal 9 and the negative electrode current collector 8 may be weld-connected.

### <Connection of Tab Portion and Current Collector>

The positive electrode current collector 6 is weld-connected to the stacked positive electrode tab portions 4. Also, the negative electrode current collector 8 is veld-connected to the stacked negative electrode tab portions 5.

### <Assembly of Battery>

The bottom-side spacer 18 is inserted in the prismatic outer body 1. The electrode body 3 is then inserted in the prismatic outer body 1 with the electrode body 3 wrapped by the insulating sheet 14 which is formed in a bag shape or a box shape. At this point, the sealing plate-side spacer 19 is preferably disposed between the sealing plate 2 and the electrode body 3. The prismatic outer body 1 and the sealing plate 2 are weld-connected to seal the opening of the prismatic outer body 1. An electrolyte solution is injected through the electrolyte solution injection hole 15 formed in the sealing plate 2, and the electrolyte solution injection hole 15 is sealed by the sealing plug 16.

### <Connection of External Connection Member>

The positive electrode terminal 7 has a flange portion 7a disposed on the outer side of the sealing plate 2 with respect to the battery, and a projection portion 7b formed at the flange portion 7a. The positive electrode external connection member 21 is formed of a metal plate and has the bolt insertion hole 28 and a projection insertion hole 29. The bolt member 27 as the positive electrode fastener 22 is inserted in the bolt insertion hole 28. The projection portion 7b of the positive electrode terminal 7 is then inserted in the projection insertion hole 29 with the external insulating member 25 disposed on the sealing plate 2. The projection portion 7b and the positive electrode external connection member 21 are weld-connected. For the negative electrode side also, connection is made in the same manner as in the positive electrode side.

In the case where a terminal and a current collector are integrated as one component or a terminal has a flange portion on the inner side of the battery, the terminal may be inserted in the terminal mounting hole of the sealing plate 2 from the inner side of the battery, and the distal end of the terminal may be fixedly swaged onto the positive electrode external connection member 21 and the negative electrode external connection member 23.

### <Modification of Gas Release Valve>

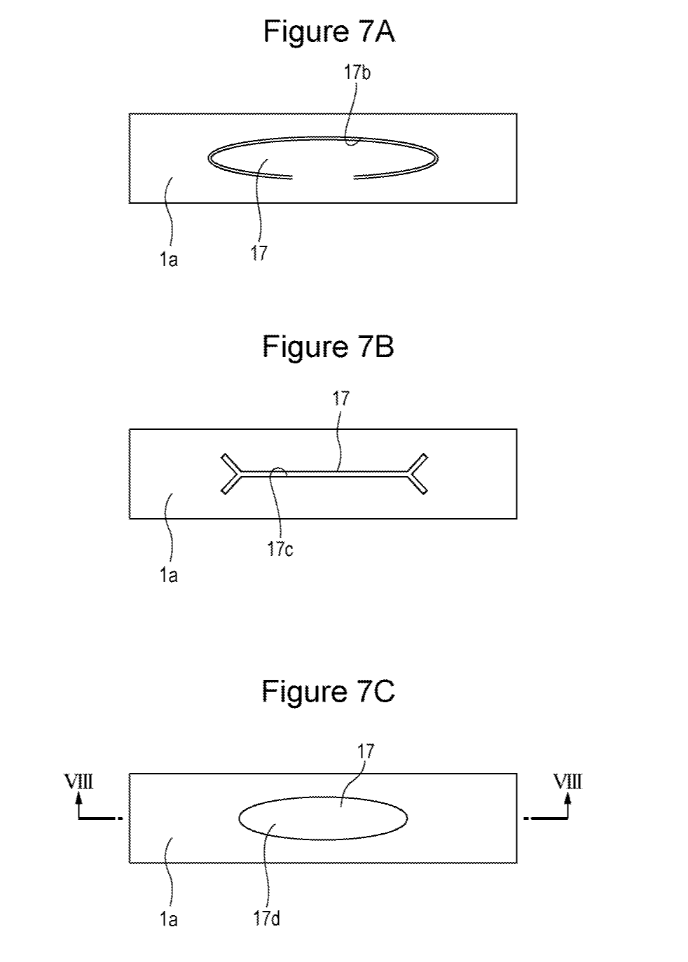

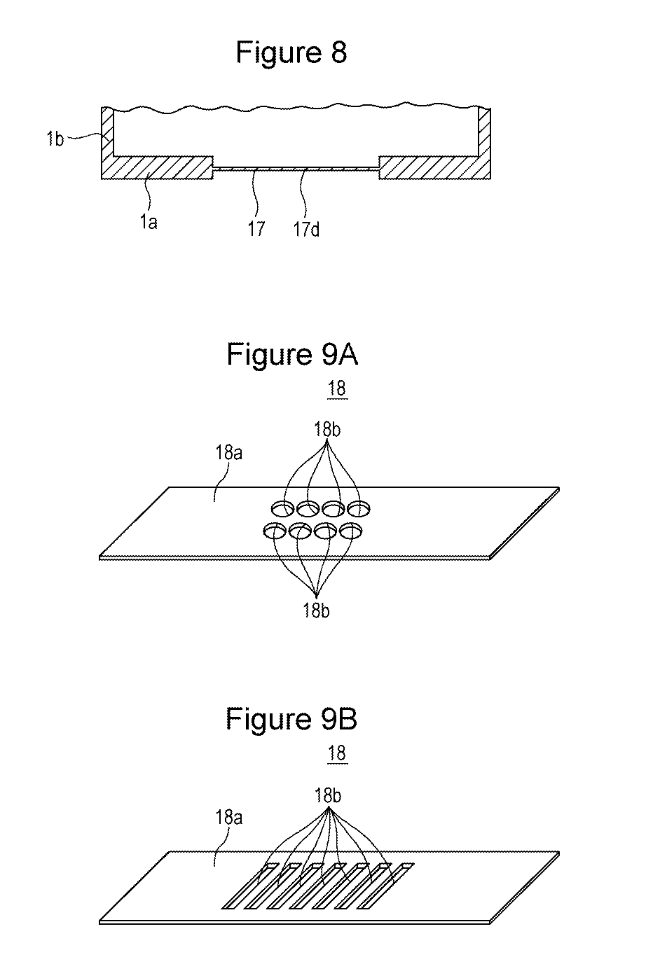

FIGS. 7A to 7C each illustrate the bottom 1a of the prismatic outer body 1 in a prismatic secondary battery as a modification. As illustrated in FIG. 7A, a groove 17b having a less thickness than other portions is provided in the bottom 1a, and the groove 17b is formed in substantially a ring shape and may serve as a gas release valve. It is to be noted that substantially a ring shape refers to a ring shape, part of which is missing. Optionally, as illustrated in FIG. 7B, a linear groove 17c may be formed. Optionally, as illustrated in FIG. 7C, a thin-walled portion 17d may be provided to serve as the gas release valve 17. It is also possible to provide a ring-shaped or substantially a ring-shaped groove in the thin-walled portion 7d. FIG. 8 is a sectional view taken along line VIII-VIII in FIG. 7C. Also, in the thin-walled portion 17d, a dome portion may be formed that projects to the inner side of the battery or the outer side of the battery. In this case, a breaking groove is preferably provided on the peripheral edge of the dome portion.

Also, the bottom 1a of the prismatic outer body 1 may be provided with a through hole as a gas release valve, and a valve element may be weld-connected to the bottom 1a to seal the through hole.

### <Modification of Bottom-Side Spacer >

FIGS. 9A and 9B illustrate a modification of the bottom-side spacer. As illustrated in 9A, a plurality of spacer through holes 18b may be provided in the main body 18a of the bottom-side spacer. With this configuration, it is possible to more reliably protect the gas release valve 17 against damage caused by the electrode body 3. As illustrated in 9B, a plurality of linear spacer through holes 18b in plan view may also be provided. In this case, the linear spacer through holes 18b preferably extend in the transverse direction of the main body 18a.

### <Modification of Prismatic Secondary Battery>

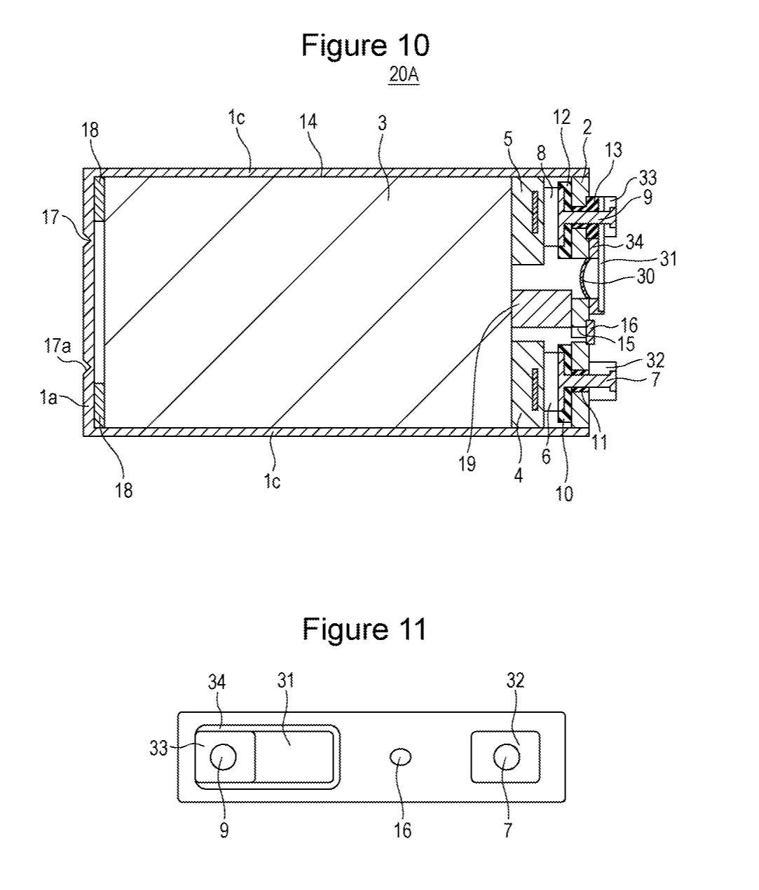

FIG. 10 illustrates a sectional view of a prismatic secondary battery 20A as a modification. FIG. 11 is a view illustrating the sealing plate 2-side face of the prismatic secondary battery 20A. The basic structure of the prismatic secondary battery 20A is the same as the structure of the prismatic secondary battery 20. The aspects of the prismatic secondary battery 20A, different from those of the prismatic secondary battery 20 will be described.

In the prismatic secondary battery 20A, the positive electrode current collector 6 and the positive electrode terminal 7 are integrally formed. An external conductive member 32 is disposed on a surface of the sealing plate 2, the surface being on the outer side of the battery. From the inner side of the battery, the positive electrode terminal 7 is inserted in the through hole of the sealing plate 2 and the through hole of the external conductive member 32, and the distal end of the positive electrode terminal 7 is fixedly swaged onto the external conductive member 32. Therefore, the positive electrode terminal 7 and sealing plate 2 are electrically connected in the prismatic secondary battery 20A.

The negative electrode current collector 8 and the negative electrode terminal 9 are integrally formed. An external conductive member 33 is disposed on a surface of the sealing plate 2 with the gasket 13 interposed therebetween, the surface being on the outer side of the battery. From the inner side of the battery, the negative electrode terminal 9 is inserted in the through hole of the sealing plate 2 and the through hole of the external conductive member 33, and the distal end of the negative electrode terminal 9 is fixedly swaged onto the external conductive member 33. It is to be noted that the negative electrode terminal 9 and the sealing plate 2 are electrically insulated from each other.

The prismatic secondary battery 20A is provided with a pressure sensitive short circuit mechanism that operates in the case where the internal pressure of the battery reaches a predetermined value or higher. The short circuit mechanism includes a deformation plate 30 provided in the sealing plate 2, and a deformation plate receiver 31 disposed outwardly of the deformation plate 30 to face the deformation plate 30. The deformation plate 30 is electrically connected to the positive electrode terminal 7 via the sealing plate 2. For instance, at normal time, the deformation plate 30 has a dome shape that projects inwardly of the battery. When the internal pressure of the battery reaches a predetermined value or higher, the deformation plate 30 is inverted and deformed to a shape that projects outwardly of the battery. The deformation plate receiver 31 is electrically connected to the negative electrode terminal 9. In this configuration, it is designed that when the internal pressure of the battery reaches a predetermined value or higher due to overcharge or the like, the deformation plate 30 is deformed to come into contact with the deformation plate receiver 31. Therefore, when the short circuit mechanism operates, the positive electrode and the negative electrode are shorted by the short circuit mechanism. This reduces the flow of charging current to the electrode body 3, and further overcharge of the prismatic secondary battery 20A may be avoided. More preferably, the positive electrode current collector 6 or the negative electrode current collector 8 is provided with a fuse part. This causes melting of the fuse part by a short-circuit current generated when the short circuit mechanism operates, thereby making it possible to reliably protect flow of charging current to the electrode body 3. It is sufficient that as the fuse part, a through hole or a notch be provided which is a portion having a smaller sectional area than other portions. It is to be noted ted that a deformation plate receiving holder 34 made of resin may be disposed between the deformation plate receiver 31 and the sealing plates 2.

It is preferable that the operating pressure of the gas release valve 17 have a larger value than the operating pressure of the short circuit mechanism.

With the configuration of the prismatic secondary battery 20A, similarly to the prismatic secondary battery 20, a high-capacity prismatic secondary battery having a high volume energy density is achieved. In addition, since a gas release valve having a larger area is allowed to be provided, a more reliably prismatic secondary battery is achieved.

Furthermore, the structure of the prismatic secondary battery 20A includes a pressure sensitive short circuit mechanism, thereby improving the reliability of the battery in an overcharge state.

The sealing plate 2 is provided with the deformation plate 30, and the bottom 1a of the prismatic outer body 1 is provided with the gas release valve 17, thereby avoiding reduction of the strength of the sealing plate 2, compared with the configuration in which the sealing plate 2 is provided with the gas release valve 17 and the deformation plate 30. When the strength of sealing plate 2 is reduced, the entire sealing plate 2 is likely to be deformed as the internal pressure of the battery increases, which causes a variation in the operating pressures of the gas release valve 17 and the deformation plate 30. Consequently, due to the configuration of the prismatic secondary battery 20A, as very highly reliable prismatic secondary battery is achieved which has a reduced variation in the operating pressures of the gas release valve 17 and the short circuit mechanism.

### <Assembled Battery>

The configuration of an assembled battery using a plurality of prismatic secondary batteries 20 or prismatic secondary batteries 20A will be described in the following. The configuration using the prismatic secondary battery 20 will be described as an example.

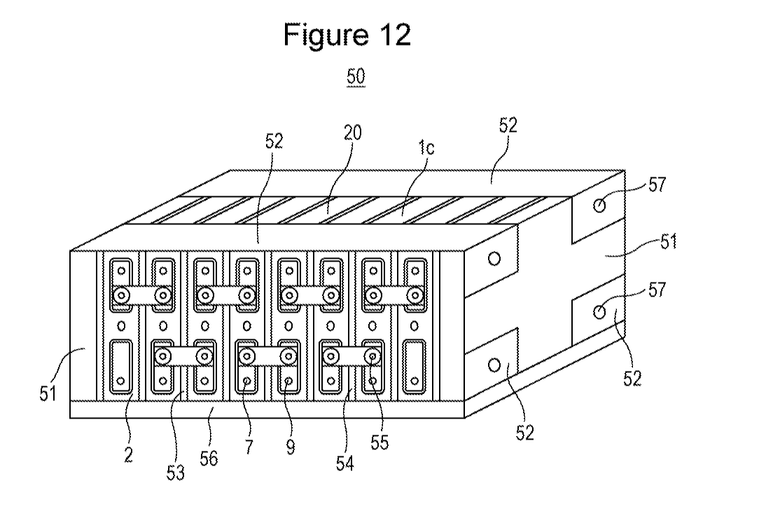

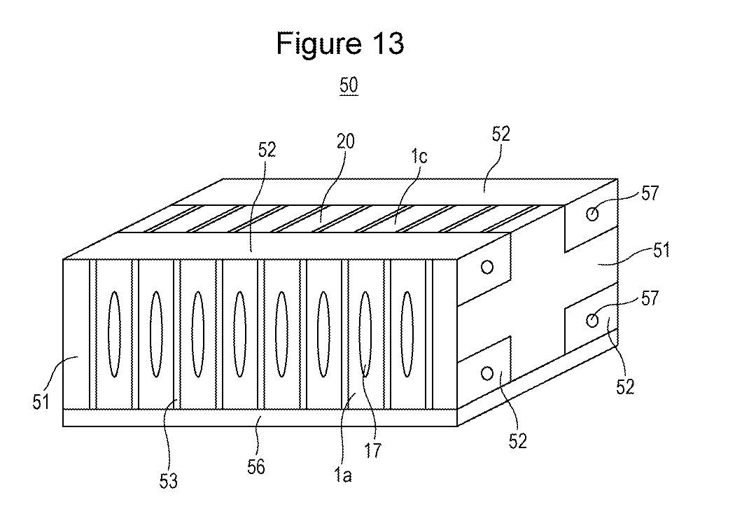

FIG. 12 and FIG. 13 are a perspective view of an assembled battery 50. In FIG. 12, the lateral face on which the sealing plate 2 is disposed is on the near side and the lateral face on which the bottom 1a of the prismatic outer body 1 is disposed is on the far side. In FIG. 13, the lateral face on which the sealing plate 2 is disposed is on the far side and the lateral face on which the bottom 1a of the prismatic outer body 1 is disposed is on the near side.

A plurality of prismatic secondary batteries 20 is stacked between a pair of end plates 51 in an orientation in which respective large-area side walls 1b are parallel. The pair of end plates 51 is connected by bind bars 52. The end plates 51 and the bind bars 52 are connected by a bolt, a rivet or the like, and fixation portions 57 are formed. Alternatively, the end plates 51 and the bind bars 52 may be weld-connected. An insulating separator 53 is disposed between adjacent prismatic secondary batteries 20, and the separator 53 is preferably composed of resin in the assembled battery 50, the positive electrode terminal 7 and the negative electrode terminal 9 of each prismatic secondary battery 20 are disposed on one lateral face. Terminals of adjacent prismatic secondary batteries 20 are connected by a bus bar 54. The bus bar 54 has two through holes. Each bolt portion of the prismatic secondary battery 20 is inserted in a through hole and is fastened by a nut 55. The bottom 1a of each prismatic secondary battery 20 is disposed on the other lateral face. The small-area side walls is of each prismatic secondary battery 20 are disposed on the upper surface and the lower surface of the assembled battery 50. By adopting this configuration, a low-height assembled battery having an extremely high volume energy density is achieved. The assembled battery 50 thus constructed is mounted in a vehicle in the vertical direction illustrated in FIG. 12 and FIG. 13, thereby achieving significantly improved occupant comfort in the vehicle.

It is to be noted that a cooling plate 56, in which a cooling medium flows, is disposed in the bottom surface of the assembled battery 50, and each prismatic secondary battery 20 is preferably cooled by the cooling plate. It is to be noted that the cooling medium may be a gas or a liquid.

In the assembled battery 50, a gas discharge duct is preferably provided on the lateral face on which the gas release valve 17 is disposed, the gas discharge duct extending in the stacking direction of the prismatic secondary battery 20. This allows discharge gas from the inside of the battery to be released to a predetermined place. The configuration of the assembled battery 50 makes it possible to dispose a gas discharge duct without restriction on the geometry and space of the positive electrode terminal and the negative electrode terminal.

When an assembled battery is produced using a plurality of prismatic secondary batteries 20A, a bus bar may be weld-connected to the external conductive members 32, 33.

### <Others>

Although the above-described embodiment has been illustrated as an example in which the electrode body 3 is a winding electrode body, the electrode body is not limited to this. The electrode body may be a stacked-type electrode body in which a plurality of positive electrode plates and a plurality of negative electrode plates are stacked via separators.

In the assembled battery, the outer body of each prismatic secondary battery is preferably wrapped by an insulating film. It is preferable that the pair of large-area side walls and the pair of small-area side walls of the prismatic outer body be each covered by an insulating film and the gas release valve of the bottom not be covered by an insulating film.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A prismatic secondary battery comprising:
an electrode body including a positive electrode plate and a negative electrode plate;
a positive electrode tab portion electrically connected to the positive electrode plate;
a negative electrode tab portion electrically connected to the negative electrode plate;
a prismatic outer body that has an opening and that houses the electrode body;
a sealing plate that seals the opening;
a positive electrode terminal that is electrically connected to the positive electrode plate and attached to the sealing plate; and
a negative electrode terminal that is electrically connected to the negative electrode plate and attached to the sealing plate,
wherein the prismatic outer body includes a bottom, a pair of large-area side walls, and a pair of small-area side walls,
an area of each of the small-area side walls is smaller than an area of each of large-area side walls,
an area of the bottom is smaller than the area of each of the small-area side walls,
the electrode body has the positive electrode tab portion and the negative electrode tab portion at one end closer to the sealing plate than the other end, and
a gas release valve is formed through which a gas in the battery is released to an outside of the battery when an internal pressure of the battery reaches a predetermined value or higher.

2. The prismatic secondary battery according to claim
wherein a battery capacity is 25 Ah or greater.

3. The prismatic secondary battery according to claim 1,
wherein a length of each of the large-area side walls in a long side direction is 10 to 20 cm, and
a length of each of the large-area side walls in a short side direction is 5 to 10 cm.

4. The prismatic secondary battery according to claim 1,
wherein the sealing plate has a first through hole and a second through hole,
the positive electrode terminal is inserted in the first through hole,
the negative electrode terminal is inserted in the second through hole,
a positive electrode external connection member is connected to the positive electrode terminal on an outer side of the sealing plate with respect to the battery, and a positive electrode fastener is connected to the positive electrode external connection member,
a negative electrode external connection member is connected to the negative electrode terminal on the outer side of the sealing plate with respect to the battery, and a negative electrode fastener is connected to the negative electrode external connection member, and
the positive electrode fastener is disposed at a position displaced from the first through hole and the negative electrode fastener is disposed at a position displaced from the second through hole in a longitudinal direction of the sealing plate.

5. The prismatic secondary battery according to claim 4,
wherein the positive electrode fastener is a positive electrode bolt member, and the negative electrode fastener is a negative electrode bolt member.

6. The prismatic secondary battery according to claim 1, further comprising
a short circuit mechanism that operates as an internal pressure of the battery increases,
the short circuit mechanism including
a deformation plate provided in the sealing plate, and
a deformation plate receiver that is disposed on an outer side of the deformation plate to face the deformation plate,
wherein the deformation plate is electrically connected to one of the positive electrode plate and the negative electrode plate,
the deformation plate receiver is electrically connected to the other of the positive electrode plate and the negative electrode plate, and
the deformation plate is deformed as the internal pressure of the battery increases, and is electrically connected to the deformation plate receiver.

7. The prismatic secondary battery according to claim 1,
wherein a spacer is disposed between the electrode body and the bottom, and a through hole is formed in the spacer.

8. An assembled battery comprising a plurality of the prismatic secondary batteries according to claim 1, the assembled battery comprising:
a pair of end plates; and
a bind bar that connects the pair of end plates,
wherein the prismatic secondary batteries are stacked between the pair of end plates in an orientation in which the respective large-area side walls are parallel,
the positive electrode terminal and the negative electrode terminal of each of the prismatic secondary batteries are disposed on one lateral face, and
the bottom of the prismatic outer body of each of the prismatic secondary batteries is disposed on the other lateral face.
